(19) United States
(12) Patent Application Publication
(10) Pub. No.: US 2020/0199400 A1
(43) Pub. Date: Jun. 25, 2020

(54) COMPOSITION INCLUDING LIQUID POLYESTER RESIN AND METHOD OF USING THE SAME

(71) Applicant: 3M INNOVATIVE PROPERTIES COMPANY, St. Paul, MN (US)

(72) Inventors: Ruijian Xu, Woodbury, MN (US); Mark F. Schulz, Lake Elmo, MN (US); Yu Yang, Eden Prairie, MN (US); Nikki D. McRae-Brown, Inver Grove Heights, MN (US); Ken Nakatani, Woodbury, MN (US)

(21) Appl. No.: 16/631,543

(22) PCT Filed: Jul. 17, 2018
(86) PCT No.: PCT/IB2018/055302

§ 371 Date: Jan. 16, 2020

Related U.S. Application Data
(60) Provisional application No. 62/533,240, filed on Jul. 17, 2017.

(51) Int. Cl. C09D 167/06; C08G 63/52; C08L 67/06; C09D 5/34; C09D 7/61

(52) U.S. Cl. CPC C09D 167/06; C08G 63/52; C09D 7/61; C09D 5/34; C08L 67/06

(57) ABSTRACT

The composition includes a liquid polyester resin comprising at least one α,β-unsaturated ester group, a tertiary amine accelerator, and up to five percent by weight of a reactive diluent having a flash point up to 150° C. A method of repairing a damaged surface using the composition is also described.

### CROSS-REFERENCE TO RELATED APPLICATION

This application claims priority to U.S. Provisional Application No. 62/533,240, filed Jul. 17, 2017, the disclosure of which is incorporated by reference in its entirety herein.

### BACKGROUND

Automobile body repair is often carried out with a body repair compound, also called body filler. A body repair compound can include a thermosetting resin, fillers, promoters, and other additives that are mixed with a catalyst to facilitate cross-linking at room temperature. After mixing, a technician spreads the body filler onto a damaged surface, allows the body filler to harden, and then sands the hardened body filler to conform to the desired surface contour. The process can be repeated two or more times until the damaged area of the vehicle is sufficiently filled, and the contour of the original surface is matched.

Automotive body fillers often include unsaturated polyester resins. Unsaturated polyester resins typically contain α,β-unsaturated polyesters and 30 to 50 percent by weight copolymerizable monomers. Styrene, due to its well-understood reactivity profiles with unsaturated polyester resins and other monomers and its relatively low cost, is by far the dominant copolymerizable monomer used in unsaturated polyester resins. Styrene has a relatively high volatility which results in its being released from both uncured resins at room temperature and at much higher rates during cure. The Environmental Protection Agency (EPA) included styrene in its Toxic Release Inventory (TRI) in 1987 and classifies it as a possible carcinogen. Organizations such as the Occupational Safety and Health Administration (OSHA) and the Clean Air Act Amendments (CAAA) have included styrene in a list of volatile organic compounds to which exposure should be limited.

Some styrene-free body filler compositions have been described. See, for example, JP2005255937, published Sep. 22, 2005, and U.S. Pat. No. 5,068,125 (Meixner et al.).

### SUMMARY

The present disclosure provides a curable resin composition that includes a liquid polyester resin, a low level of reactive diluent and/or volatile organic components, and an active amine catalyst. The composition can be cured using standard free radical polymerization at ambient condition and can be formulated as a body filler. The composition can provide adhesion and sanding properties comparable to existing body fillers that contain higher levels of volatile organic compounds.

In one aspect, the present disclosure provides a composition including a liquid polyester resin comprising at least one α,β-unsaturated ester group, a tertiary amine accelerator, and up to five percent by weight of a reactive diluent having a flash point up to 150° C.

In another aspect, the present disclosure provides a cured composition prepared from such a composition.

In another aspect, the present disclosure provides a method of repairing a damaged surface. The method includes combining the composition described above with at least one of an organic peroxide or organic hydroperoxide, applying the composition comprising the organic peroxide or hydroperoxide to the damaged surface; and curing the composition on the damaged surface.

In this application:

Terms such as “a”, “an” and “the” are not intended to refer to only a singular entity, but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility, but may be swellable in the presence of an appropriate solvent.

The term “polymer or polymeric” will be understood to include polymers, copolymers (e.g., polymers formed using two or more different monomers), oligomers or monomers that can form polymers, and combinations thereof, as well as polymers, oligomers, monomers, or copolymers that can be blended.

“Alkyl group”, “alkenyl group” and the prefix “alk-” are inclusive of both straight chain and branched chain groups. In some embodiments, alkyl groups have up to 30 carbons (in some embodiments, up to 20, 15, 12, 10, 8, 7, 6, or 5 carbons) unless otherwise specified.

“Alkylene” is the multivalent (e.g., divalent or trivalent) form of the “alkyl” groups defined above. “Alkenylene” is the multivalent (e.g., divalent or trivalent) form of the “alkenyl” groups defined above.

“Arylalkylene” refers to an “alkylene” moiety to which an aryl group is attached. “Alkylarylene” refers to an “arylene” moiety to which an alkyl group is attached.

The phrase “interrupted by at least one —O— group”, for example, with regard to an alkyl, alkenyl, alkylene, or alkenylene group refers to having part of the alkyl or alkylene on both sides of the —O— group. For example, —CH₂CH₂—O—CH₂—CH₂— is an alkylene group interrupted by an —O—. This definition applies to the other functional groups recited herein (e.g., —N(H)—, —N(H)—C(O)—, etc.).

The terms “aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term (meth)acrylate refers to an acrylate, a methacrylate, or a combination thereof. Similarly, the term (meth)acrylic refers to acrylic, a methacrylic, or a combination thereof.

The term “liquid” refers to being able to flow at ambient temperature.

Flash point is determined by the ASTM D93 Pensky-Martens method.

A “volatile organic compound” is a compound having at least one carbon atom that participates in atmospheric photochemical reactions. Unless otherwise specified, a volatile organic compound has at least one of a vapor pressure of greater than 0.1 mm Hg at 20° C. or a boiling point of less than 216° C.

All numerical ranges are inclusive of their endpoints and non-integral values between the endpoints unless otherwise stated (e.g., 1 to 5 includes 1, 1.5, 2, 2.75, 3, 3.80, 4, 5, etc.).

### DETAILED DESCRIPTION

The composition according to the present disclosure includes a liquid polymeric resin having at least one α,β-unsaturated ester group. Unsaturated α,β-unsaturated ester groups have the formula C═C—C(O)—O—. The terminal carbon of the double bond may be bonded to two hydrogen atoms, making it a terminal olefin group, or one or two other carbon atoms, making it an internal olefin. The terminal oxygen of the ester group is typically bonded to a carbon atom in the resin.

The composition according to the present disclosure includes an unsaturated polyester resin. Unsaturated polyester resins include a polyester generally formed by a polycondensation reaction of an unsaturated dicarboxylic acid or an anhydride thereof with a multifunctional hydroxy compound. Unsaturated dicarboxylic acids useful for preparing the unsaturated polyester resin typically include α,β-unsaturated acids and anhydrides thereof (e.g., maleic anhydride, maleic acid, fumaric acid, itaconic acid, citraconic acid, and citraconic anhydride). Other dicarboxylic acids or equivalents can also be included in the preparation of the unsaturated polyester resin. Examples include saturated aliphatic dicarboxylic acids having 4 to 10 carbon atoms such as succinic acid, adipic acid, sebacic acid and/or their anhydrides; cycloaliphatic dicarboxylic acids or dicarboxylic acid anhydrides having 8 to 10 carbon atoms such as tetrahydrophthalic acid, hexahydrophthalic acid, norbornene dicarboxylic acid and/or their anhydrides; and aromatic dicarboxylic acids or dicarboxylic acid anhydrides having 8 to 12 carbon atoms such as phthalic acid, phthalic anhydride, isophthalic acid, and terephthalic acid. Examples of hydroxy compounds useful for making unsaturated polyester resins include 1,2-propanediol, 1,3-propanediol, dipropylene glycol, diethylene glycol, ethylene glycol, 1,3-butanediol, 1,4-butanediol, neopentyl glycol, triethylene glycol, tripropylene glycol, and polyethylene glycols. In some embodiments, the hydroxy compounds used to make the unsaturated polyester resin excludes alkoxylated 2-butene-1,4-diol (e.g., those described in U.S. Pat. No. 5,360,863 (Meixner et al.).

The unsaturated polyester resin useful for practicing the present disclosure can comprise a dicyclopentadiene-modified unsaturated polyester resin. Dicyclopentadiene has been used to modify unsaturated polyester resins in various ways. For example, cracking dicyclopentadiene (e.g., heating at a temperature of at least 140° C.) forms cyclopentadiene, which can undergo a Diels-Alder reaction with maleic acid or maleic anhydride to form nadic acid or nadic anhydride groups in the polyester backbone. In another example, maleic acid can react with one or fewer equivalents of dicyclopentadiene to form a dicyclopentenyl monoester of maleic acid. The reaction is typically carried out at a temperature lower than 140° C. to avoid cracking the dicyclopentadiene. The dicyclopentenyl monoester can then be combined with a dihydroxy compound and optionally an unsaturated dicarboxylic acid or an anhydride thereof to provide a dicyclopentenyl-end-capped polyester resin.

The liquid polyester resin useful for practicing the present disclosure may further include other end-group modifications. For example, the liquid polyester resin can be prepared in the presence of a vinyl monocarboxylic acid (e.g., acrylic acid, methacrylic acid, ethacrylic acid, halogenated acrylic or methacrylic acids, cinnamic acid, and combinations thereof) to provide vinyl end groups. In another example, allyl glycidyl ether and/or an unsaturated ether that is a monofunctional hydroxy compound with at least one beta, gamma-unsaturated alkenyl ether group can be useful for incorporating allyl ether end groups into the liquid polyester resin. In some embodiments, the liquid polyester resin comprises allyl ether groups.

Mixtures of different unsaturated polyester resins may be useful in the composition according to the present disclosure. For example, a mixture of unsaturated polyesters made from different unsaturated dicarboxylic acids or anhydrides thereof and/or different dihydroxy compounds can be useful. Mixtures of dicyclopentadiene-modified unsaturated polyester resins (in some embodiments, dicyclopentenyl-end-capped polyester resin) and polyester resins not modified with dicyclopentadiene are also useful, for example, to provide a cured composition with a desirable modulus.

Liquid unsaturated polyester resins useful for practicing the present disclosure can have a wide variety of molecular weights. Whether an unsaturated polyester resin is liquid can depend, for example, on its structure (e.g., backbone and end groups) and its molecular weight. In some embodiments, the unsaturated polyester resins can have weight average molecular weights in a range from 500 grams per mole to 5,000 grams per mole, 1,000 grams per mole to 5,000 grams per mole, or 1000 grams per mole to 3,000 grams per mole, as measured by gel permeation chromatography using polystyrene standards or number average molecular weights in a range from 500 grams per mole to 5,000 grams per mole, 1,000 grams per mole to 5,000 grams per mole, or 1000 grams per mole to 3,000 grams per mole as calculated from the water collected from the condensation reaction.

The synthesis of unsaturated polyesters occurs either by a bulk condensation or by azeotropic condensation in batch. The reaction can conveniently be carried out in a flask equipped with stirrer, condenser, and a jacket heater. The starting materials are typically added to the flask at room temperature and then slowly heated to a temperature in a range from 200° C. to 250° C. under conditions where water can be removed from the reaction mass to obtain desired molecular weight.

Some unsaturated polyester resins useful for practicing the present disclosure can be obtained from commercial sources, for example, Reichhold LLC, Durham, N.C.; Polynt Composites, USA, Inc., North Kansas City, Mo.; AOC, LLC, Collierville, Tenn.; DSM Resins U.S., Inc., Augusta, Ga.; Ashland Specialty Chemical Co., Columbus, Ohio; Bayer Material Science LLC, Pittsburgh, Pa.; Interplastic Corporation, St. Paul, Minn.; and Deltech Corporation, Baton Rouge, La.

The composition according to the present disclosure can include a vinyl ester resin. As would be understood by a person of ordinary skill in the art, a vinyl ester is a resin produced by the esterification of an epoxy resin with an unsaturated monocarboxylic acid. Epoxy vinyl ester resins are typically prepared, for example, by reacting a vinyl monocarboxylic acid (e.g., acrylic acid, methacrylic acid, ethacrylic acid, halogenated acrylic or methacrylic acids, cinnamic acid, and combinations thereof) and an aromatic polyepoxide (e.g., a chain-extended diepoxide or novolac epoxy resin having at least two epoxide groups) or a monomeric diepoxide. Useful epoxy vinyl ester resins typically have at least two end groups represented by formula —CH₂—CH(OH)—CH₂—O—C(O)—C(R″)═CH(R), wherein R″ is hydrogen, methyl, or ethyl, wherein the methyl or ethyl group may optionally be halogenated, wherein R′ is hydrogen or phenyl, and wherein the terminal CH₂ group is linked directly or indirectly to the aromatic group described below (e.g., through a phenolic ether functional group). The aromatic polyepoxide or aromatic monomeric diepoxide typically contains at least one (in some embodiments, at least 2, in some embodiments, in a range from 1 to 4) aromatic ring that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For epoxy resins containing two or more aromatic rings, the rings may be connected, for example, by a branched or straight-chain alkylene group having 1 to 4 carbon atoms that may optionally be substituted by halogen (e.g., fluoro, chloro, bromo, iodo).

Examples of aromatic epoxy resins useful for reaction with vinyl monocarboxylic acids include novolac epoxy resins (e.g., phenol novolacs, ortho-, meta-, or para-cresol novolacs or combinations thereof), bisphenol epoxy resins (e.g., bisphenol A, bisphenol F, halogenated bisphenol epoxies, and combinations thereof), resorcinol epoxy resins, and tetrakis phenylolethane epoxy resins. Examples of aromatic monomeric diepoxides useful for reaction with vinyl monocarboxylic acids include the diglycidyl ethers of bisphenol A and bisphenol F and mixtures thereof. In some embodiments, bisphenol epoxy resins, for example, may be chain extended to have any desirable epoxy equivalent weight. In some embodiments, the aromatic epoxy resin (e.g., either a bisphenol epoxy resin or a novolac epoxy resin) may have an epoxy equivalent weight of at least 140, 150, 200, 250, 300, 350, 400, 450, or 500 grams per mole. In some embodiments, the aromatic epoxy resin may have an epoxy equivalent weight of up to 2500, 3000, 3500, 4000, 4500, 5000, 5500, or 6000 grams per mole. In some embodiments, the aromatic epoxy resin may have an epoxy equivalent weight in a range from 150 to 6000, 200 to 6000, 200 to 5000, 200 to 4000, 250 to 5000, 250 to 4000, 300 to 6000, 300 to 5000, or 300 to 3000 grams per mole.

Several aromatic epoxy vinyl ester resins useful for the composition of the present disclosure are commercially available. For example, epoxy diacrylates such as bisphenol A epoxy diacrylates and epoxy diacrylates diluted with other acrylates are commercially available, for example, from Cytec Industries, Inc., Smyrna, Ga., under the trade designation “EBECRYL”. Aromatic epoxy vinyl ester resins such as novolac epoxy vinyl ester resins diluted with styrene are available, for example, from Ashland, Inc., Covington, Ky., under the trade designation “DERAKANE” (e.g., “DERAKANE 470-300”) and from Interplastic Corporation, St. Paul, Minn., under the trade designation “CoREZYN” (e.g., “CoREZYN 8730” and “CoREZYN 8770”).

The composition according to the present disclosure and/or useful for practicing the present disclosure can include up to five percent by weight of a reactive diluent having a flash point up to 150° C. The composition according to the present disclosure and/or useful for practicing the present disclosure can include up to 4, 3, 2, 1, 0.5, 0.25, or 0.1 percent by weight of a reactive diluent having a flash point up to 150° C. The composition according to the present disclosure and/or useful for practicing the present disclosure can be free of reactive diluent having a flash point up to 150° C.

Some common reactive diluents having a flash point up to 150° C. are vinyl aromatic compounds having at least one vinyl substituent on an aromatic ring, typically a benzene ring or a naphthalene ring. In addition to the vinyl substituent, the vinyl aromatic compound may also include other substituents (e.g., alkyl, alkoxy, or halogen). Examples of such vinyl aromatic compounds include styrene, alpha-methyl styrene, p-methyl styrene, p-tert-butyl styrene, chlorostyrene, dichlorostyrene, p-ethoxystyrene, p-propoxystyrene, divinyl benzene, and vinyl naphthalene. Reactive diluents also include vinyl ethers such as ethyl vinyl ether, n-propyl vinyl ether, iso-propyl vinyl ether, n-butyl vinyl ether, iso-butyl vinyl ether, cyclohexyl vinyl ether, hydroxybutyl vinyl ether, cyclohexanedimethanol divinyl ether, triethyleneglycol divinyl ether, butanediol divinyl ether, cyclohexanedimethanol monovinyl ether, diethyleneglycol divinyl ether, 2-ethylhexyl vinyl ether, dodecyl vinyl ether, octadecyl vinyl ether, hexanediol divinyl ether, dipropyleneglycol divinyl ether, and tripropyleneglycol divinyl ether. Reactive diluents can also include acrylate and methacrylates such as methyl (meth)acrylate, ethyl (meth)acrylate, isopropyl (meth)acrylate, n-butyl (meth)acrylate, isobutyl (meth)acrylate, 2-ethylhexyl (meth)acrylate, lauryl (meth)acrylate, ethylene glycol dicyclopentenyl ether (meth)acrylate, and propanediol dicyclopentenyl ether (meth)acrylate. Hydroxy-functionalized (meth)acrylates that can be used as reactive diluents include hydroxyethyl methacrylate, hydroxypropyl methacrylate, hydroxyethyl acrylate, and hydroxypropyl acrylate. Multifunctional (meth)acrylate monomers that can be used as reactive diluents include 1,4-butanediol diacrylate, 1,6-hexanediol diacrylate, diethylene glycol diacrylate, 1,3-butylene glycol diacrylate, neopentyl glycol diacrylate, cyclohexane dimethanol diacrylate, dipropylene glycoldiacrylate, ethoxylated bisphenol A diacrylate, trimethylolpropane triacrylate, pentaerythritol triacrylate, pentaerythritol tetraacrylate and their related (meth)acrylate derivatives. These reactive diluents have flash points up to 150° C. In some cases, these reactive diluents have flash points up to 125° C., 100° C., or 80° C. The composition according to the present disclosure and/or useful for practicing the present disclosure can include up to 5, 4, 3, 2, 1, 0.5, 0.25, or 0.1 percent by weight of any of these reactive diluents or can be free of any of these reactive diluents. In some embodiments, the composition according to the present disclosure and/or useful for practicing the present disclosure can include up to 5, 4, 3, 2, 1, 0.5, 0.25, or 0.1 percent by weight of triethylene glycol divinyl ether or can be free of triethylene glycol divinyl ether. In some embodiments, the composition according to the present disclosure and/or useful for practicing the present disclosure can include up to 5, 4, 3, 2, 1, 0.5, 0.25, or 0.1 percent by weight of any vinyl ether or can be free of vinyl ethers. In some embodiments, the composition according to the present disclosure and/or useful for practicing the present disclosure can include up to 5, 4, 3, 2, 1, 0.5, 0.25, or 0.1 percent by weight of ethylene glycol dicyclopentenyl ether (meth)acrylate and propanediol dicyclopentenyl ether (meth)acrylate or can be free of ethylene glycol dicyclopentenyl ether (meth)acrylate and propanediol dicyclopentenyl ether (meth)acrylate. In some embodiments, the composition according to the present disclosure and/or useful for practicing the present disclosure can include up to 5, 4, 3, 2, 1, 0.5, 0.25, or 0.1 percent by weight lauryl (meth)acrylate or can be free of lauryl (meth)acrylate. In some embodiments, the composition according to the present disclosure and/or useful for practicing the present disclosure can include up to 5, 4, 3, 2, 1, 0.5, 0.25, or 0.1 percent by weight of any acrylate or methacrylate or can be free of acrylates and methacrylates. These percentages are based on the total weight of liquid polymeric resin and reactive diluent in the composition.

The composition according to the present disclosure and/or useful for practicing the present disclosure can include up to 15 percent by weight of volatile organic compounds (VOCs). A VOC generally has at least one of a vapor pressure of greater than 0.1 mm Hg at 20° C. or a boiling point of less than 216° C. In some embodiments, a VOC has a vapor pressure of greater than 0.05 mm Hg at 20° C. or 0.02 mm Hg at 20° C. In some embodiments, a VOC has a boiling point of less than 200° C. or less than 185° C. VOCs can include the reactive diluents described above and solvents such as those not listed as “exempt” or otherwise excluded in the California Consumer Products Regulations, Subchapter 8.5, Article 2, 94508, last amended Sep. 17, 2014 (Register 2014, No. 38). Such solvents, which are not exempt, include hydrocarbon solvents (e.g., benzene, toluene, xylenes, and d-limonene); acyclic and cyclic ketones (e.g., pentanone, hexanone, cyclopentanone, and cyclohexanone); acyclic or cyclic acetals, ketals or ortho esters (e.g., diethoxy methane, dimethoxy methane, dipropoxy methane, dimethoxy ethane, diethoxy ethane, dipropoxy ethane, 2,2-dimethoxy propane, 2,2-diethoxy propane, 2,2-dipropoxy propane, 2,2-dimethyl-1,3-dioxalane, trimethyl orthoformate, triethyl orthoformate, trimethyl orthoacetate, triethyl orthoacetate, trimethyl orthobenzoate, and triethyl orthobenzoate); and alcoholic solvents (e.g., methanol, ethanol, or propanol such as isopropanol). A person skilled in the art can readily determine which solvents have exempt or excluded status in the California Consumer Products Regulations. In some cases, VOCs have flash points up to 100° C. or 80° C. The composition according to the present disclosure and/or useful for practicing the present disclosure can include up to 14, 13, 12, 10, 9, 8, 7, 6, 5, 4, 3, 2, 1, 0.5, 0.25, or 0.1 percent by weight of any of these VOCs or can be free of any of these VOCs. These percentages are based on the total weight of liquid polymeric resin and other liquid components in the composition.

The composition according to and/or useful for practicing the present disclosure includes a tertiary amine, which is useful for accelerating the free-radical curing of the composition at room temperature. Useful tertiary amines include N,N-dialkyl toluidines, where each alkyl group is optionally substituted by hydroxyl and independently selected from among methyl, ethyl, hydroxyethyl, hydroxylpropyl, isopropyl and mixtures thereof); trialkyl amines, where each alkyl is optionally substituted by hydroxyl and independently selected from among ethyl, propyl, and hydroxyethyl; N,N-dialkylanilines (e.g., N,N-dimethylaniline and N,N-diethylaniline); 4,4-bis(dimethylamino) diphenylmethane; and mixtures of any of these. In some embodiments, the accelerator is N,N-diisopropanol-p-toluidine, N,N-dihydroxyethyl-p-toluidine; N,N-methylhydroxyethyl-p-toluidine, or a mixture of these. The accelerator is generally present in a catalytic (that is, sub-stoichiometric) amount in the composition. Any useful amount of accelerator may be included in the composition. In some embodiments, an accelerator is included in the composition in an amount up to 2, 1, 0.75, or 0.5 percent by weight, based on the total weight of the composition.

The composition according to the present disclosure may also include another accelerant, for example, for a peroxide initiator. The selection of accelerant(s) appropriate for use in the composition according to the present disclosure depends, for example, upon selection of the peroxide initiator. Inorganic materials as well as organic salts may also be useful as accelerants in the composition according to the present disclosure. Examples of suitable inorganic and organometallic accelerants include magnesium, tin, and cobalt salts such as cobalt naphthenate. Mixtures of these accelerants may also be useful, and mixtures any of the organic, inorganic, and organometallic accelerators described above may be useful.

In some embodiments, the composition according to the present disclosure and/or useful for practicing the present disclosure further includes one or more reactive compounds having a flash point of greater than 150° C. and having at least one of an amino, mercaptan, epoxy, hydroxy, or olefin group. The flash point of one or more of the reactive compounds can be at least 160° C., 170° C., 180° C., 190° C., or 200° C. Mixtures of reactive compounds having different functional groups may be useful. Compositions including reactive compounds having these flash points can be considered non-flammable, which is advantageous for their storage and handling. In some embodiments, reactive compounds having at least one mercaptan group can be useful. In some embodiments, reactive compounds having at least one epoxy group (e.g., epoxy resins) can be useful. In some embodiments, mixtures of epoxy resins and multi-functional mercaptans can be useful. Useful reactive compounds having one or more mercaptan groups include “POLYTHIOL QE-340M” curing agent from Toray Fine Chemicals, Co., Ltd., Tokyo, Japan, and a mercaptan terminated liquid resin, obtained under the trade designation “GABEPRO GPM-800” from Gabriel Performance Products, Akron, Ohio.

Epoxy resins useful in the compositions disclosed herein can include aromatic epoxy resins. Examples of aromatic epoxy resins useful in the compositions disclosed herein include novolac epoxy resins (e.g., phenol novolacs, ortho-, meta-, or para-cresol novolacs or combinations thereof), bisphenol epoxy resins (e.g., bisphenol A, bisphenol F, halogenated bisphenol epoxies, and combinations thereof), resorcinol epoxy resins, and tetrakis phenylolethane epoxy resins. In some embodiments, bisphenol epoxy resins, for example, may be chain extended to have any desirable epoxy equivalent weight. In some embodiments, the aromatic epoxy resin (e.g., either a bisphenol epoxy resin or a novolac epoxy resin) may have an epoxy equivalent weight of at least 140, 150, 200, 250, 300, 350, 400, 450, or 500 grams per mole. In some embodiments, the aromatic epoxy resin may have an epoxy equivalent weight of up to 2500, 3000, 3500, 4000, 4500, 5000, 5500, or 6000 grams per mole. In some embodiments, the aromatic epoxy resin may have an epoxy equivalent weight in a range from 150 to 6000, 200 to 6000, 200 to 5000, 200 to 4000, 250 to 5000, 250 to 4000, 300 to 6000, 300 to 5000, or 300 to 3000 grams per mole. Useful epoxy resins are available from a variety of commercial sources, for example, Hexion, Inc., Stafford, Tex.

In some embodiments, the composition according to the present disclosure and/or useful for practicing the present disclosure includes an amino- or mercapto-substituted compound represented by formula (HD)₁₋₄-R. In this formula, each D is independently —S— or —N(H)—. In some embodiments, D is —N(H)—, and the compound represented by formula (HD)₁₋₄-R has at least one amino group. In some embodiments, when more than one DH group is present each one is either —S— or —N(H)—. In formula (HD)₁₋₄-R, R is a monovalent alkyl, alkenyl, or polyalkyleneoxy or a multivalent alkylene, alkenylene, or polyalkyleneoxy that is interrupted by at least two ether (i.e., —O—), amine (i.e., —N(H)—), amide (i.e., —N(H)—C(O)—), thioester (i.e., —S—C(O)—), or ester (i.e., —O—C(O)—) groups or a combination thereof. In some embodiments, R is alkenylene that is interrupted by at least one amine (i.e., —N(H)—) and at least one amide (i.e., —N(H)—C(O)—). In some embodiments, R is polyalkyleneoxy with a molecular weight up to 2500, 2000, 1500, 1000, or 500. In the polyalkyleneoxy, the alkylene groups comprise at least one of ethylene or propylene groups.

In some embodiments, the amino- or mercapto-substituted compound represented by formula (HD)₁₋₄-R is represented by formula HD-R¹-Q-R², wherein R¹ is alkylene that is interrupted by at least one —N(H)— or —O—; Q is —N(H)—C(O)—, —S—C(O)—, or —O—C(O)—; and R² is alkyl or alkenyl. In some of these embodiments, Q is —N(H)—C(O)— or —O—C(O)—. In some embodiments, Q is a —N(H)—C(O)—. In some embodiments, R² is alkyl or alkenyl having from 8 to 14, 8 to 13, or 8 to 12 carbon atoms. Compounds of formula HD-R¹-Q-R² can be made, for example, by reaction of a diamine or dithiol with a saturated or unsaturated fatty acid. Diamines and dithiols useful for making these compounds include polyethylenepolyamines (e.g., diethylenetriamine, triethylenetetramine, or tetraethylenepentamine) and polyether diamines with a molecular weight up to 2500, 2000, 1500, 1000, or 500, HSCH₂CH₂OCH₂CH₂OCH₂CH₂SH, pentaerythritol tetra(3-mercaptopropionate), trimethylolpropane tris(3-mercaptoproionate), and ethylene glycol bis (3-mercaptopropionate). Useful polyether amines are commercially available, for example, under the trade designation “JEFFAMINE” from Huntsman Chemical, The Woodlands, Tex., and from BASF, Florham Park, N.J. The molecular weights are typically provided by the manufacturer.

Useful compounds of formula HD-R¹-Q-R² include compounds in which D is —N(H)—, R¹ is alkylene that is interrupted by at least one —N(H)—, Q is —N(H)—C(O)—, and R² is alkenyl having 8 to 14 carbon atoms. In some embodiments, the compound represented by formula HD-R¹-Q-R² is H₂N(CH₂CH₂NH)₄C(O)(CH₂)₇C(H)═C(H)—(CH₂)₃CH₃.

Reactive compounds having a flash point of greater than 150° C. and one or more olefin groups include methacrylated fatty acids, such as those available, for example, from Croda Inc. Edison, N.J. or those available under the trade designation “MC818” from Dixie Chemical Company, Inc, Pasadena, Tex. Such compounds can also be prepared, for example, by the methods described in U.S. Pat. No. 8,372,926 (Palmese et al.).

Compositions according to the present disclosure typically include the one or more reactive compounds having a flash point of at least 150° C. in an amount of up to 40% by weight based on the total of liquid polyester resin and reactive compound. In some embodiments, the composition according to the present disclosure includes the reactive compound having a flash point of at least 150° C. in an amount in a range from 1% by weight to 40% by weight, 2% by weight to 30% by weight, 5% by weight to 30% by weight, or 10% by weight to 30% by weight based on the total of liquid polyester resin and reactive compound.

The composition according to the present disclosure and/or useful for practicing the present disclosure can include one or more radical inhibitors. Examples of useful classes of radical inhibitors include phenolic compounds, stable radicals like galvinoxyl and N-oxyl based compounds, catechols, and phenothiazines Examples of useful radical inhibitors that can be used in composition according to the present disclosure include 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, naphthoquinone, 1-oxyl-2,2,6,6-tetramethylpiperidine, 1-oxyl-2,2,6,6-tetramethylpiperidine-4-ol, 1-oxyl-2,2,6,6-tetramethylpiperidine-4-one, 1-oxyl-2,2,6,6-tetramethyl-4-carboxyl-piperidine, 1-oxyl-2,2,5,5-tetramethylpyrrolidine, 1-oxyl-2,2,5,5-tetramethyl-3-carboxylpyrrolidine, aluminium-N-nitrosophenyl hydroxylamine, diethylhydroxylamine, phenothiazine and/or derivatives or combinations of any of these compounds. Any useful amount of radical inhibitor may be included in the composition disclosed herein. In some embodiments, the amount of radical inhibitor in the composition according to the present disclosure is in the range of from 0.0001% to 10% (in some embodiments, 0.001% to 1%) by weight, based on the total weight of resin and other reactive components.

The composition according to the present disclosure may also include a filler. In some embodiments, the composition according to the present disclosure includes at least one of ceramic beads, polymer beads, silica, hollow ceramic elements, hollow polymeric elements, alumina, zirconia, mica, dolomite, wollastonite, fibers, talc, calcium carbonate, sodium metaborate, or clay. Such fillers, alone or in combination, can be present in the composition according to the present disclosure in a range from 10 percent by weight to 70 percent by weight, in some embodiments, 20 percent by weight to 60 percent by weight or 40 percent by weight to 60 percent by weight, based on the total weight of the composition. Silica, alumina, and zirconia, for example, can be of any desired size, including particles having an average size above 1 micrometer, between 100 nanometers and 1 micrometer, and below 100 nanometers. Silica can include nanosilica and amorphous fumed silica, for example. The term “ceramic” refers to glasses, crystalline ceramics, glass-ceramics, and combinations thereof. Hollow ceramic elements can include hollow spheres and spheroids. Examples of commercially available materials suitable for use as the hollow, ceramic elements include glass bubbles marketed by 3M Company, Saint Paul, Minn., as “3M GLASS BUBBLES” in grades K1, K15, K20, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”; glass bubbles marketed by Potters Industries, Carlstadt, N.J., under the trade designations “Q-CEL HOLLOW SPHERES” (e.g., grades 30, 6014, 6019, 6028, 6036, 6042, 6048, 5019, 5023, and 5028); and hollow glass particles marketed by Silbrico Corp., Hodgkins, Ill. under the trade designation “SIL-CELL” (e.g., grades SIL 35/34, SIL-32, SIL-42, and SIL-43). The hollow, ceramic elements may also be made from ceramics such as alpha-alumina, zirconia, and alumina silicates. In some embodiments, the hollow, ceramic elements are aluminosilicate microspheres extracted from pulverized fuel ash collected from coal-fired power stations (i.e., cenospheres). Useful cenospheres include those marketed by Sphere One, Inc., Chattanooga, Tenn., under the trade designation “EXTENDOSPHERES HOLLOW SPHERES” grades SG, MG, CG, TG, HA, SLG, SL-150, 300/600, 350 and FM-1). Other useful hollow, ceramic spheroids include silica-alumina ceramic hollow spheres with thick walls marketed by Valentine Chemicals of Lockport, La., as ZEEOSPHERES CERAMIC MICROSPHERES in grades N-200, N-200PC, N-400, N-600, N-800, N1000, and N1200. The hollow ceramic elements may have one of a variety of useful sizes but typically has a maximum dimension, or average diameter, of less than 10 millimeters (mm), more typically less than one mm. In some embodiments, the hollow ceramic elements have a maximum dimension in a range from 0.1 micrometer to one mm, from one micrometer to 500 micrometers, from one micrometer to 300 micrometers, or even from one micrometer to 100 micrometers. The mean particle size of the hollow, ceramic elements may be, for example, in a range from 5 to 250 micrometers (in some embodiments from 10 to 110 micrometers, from 10 to 70 micrometers, or even from 20 to 40 micrometers). As used herein, the term size is considered to be equivalent with the diameter and height, for example, of glass bubbles. In some embodiments, each of the fillers in the composition according to the present disclosure has a mean particle size up to 100 micrometers as described in U.S. Pat. No. 8,034,852 (Janssen et al.). Compositions according to the present disclosure can also include dyes, pigments, rheology modifiers (e.g., fumed silica or clay).

Compositions according to the present disclosure can be packaged, for example, as a two-part composition (e.g., body repair composition), wherein a first part comprises the composition including any of the components described above, and a second part comprises a free-radical initiator (e.g., organic peroxide or organic hydroperoxide). The volumetric ratio of the first to second part may be in the range of, e.g., 20:1 or higher, or 25:1 or higher, or 30:1 or higher for unsaturated polyester resins with a peroxide catalyst as an initiator.

Examples of useful organic peroxides and hydroperoxides include hydroperoxides (e.g., cumene, tert-butyl or tert-amyl hydroperoxide), dialkyl peroxides (e.g., di-tert-butylperoxide, dicumylperoxide, or cyclohexyl peroxide), peroxyesters (e.g., tert-butyl perbenzoate, tert-butyl peroxy-2-ethylhexanoate, tert-butyl peroxy-3,5,5-trimethylhexanoate, tert-butyl monoperoxymaleate, or di-tert-butyl peroxyphthalate), and diacylperoxides (e.g., benzoyl peroxide or lauryl peroxide). Other examples of useful organic peroxides include peroxycarbonates (e.g., tert-butylperoxy 2-ethylhexylcarbonate, tert-butylperoxy isopropyl carbonate, or di(4-tert-butylcyclohexyl) peroxydicarbonate) and ketone peroxides (e.g., methyl ethyl ketone peroxide, 1,1-di(tert-butylperoxy)cyclohexane, 1,1-di(tert-butylperoxy)-3,3,5-trimethylcyclohexane, and cyclohexanone peroxide). The organic peroxide may be selected, for example, based on the temperature desired for use of the organic peroxide and compatibility with the polymeric resin desired to be cured. For curing at room temperature, benzoyl peroxide, cumene hydroperoxide, cyclohexanone peroxide, diisopropylbenzene dihydroperoxide, t-butyl monoperoxymaleate, lauryl peroxide, methyl ethyl ketone peroxide, t-butyl hydroperoxide, or mixtures thereof may be useful. Any useful amount of organic peroxide and/or hydroperoxide may be combined with the composition. In some embodiments, at least one of a peroxide or hydroperoxide is combined with the composition in an amount up to 5, 3, 2.5, or 2 percent by weight, based on the total weight of the composition.

For convenience, when adding organic peroxides and hydroperoxides to a composition according to the present disclosure, the peroxide may be used in a formulation (e.g., paste) that also includes a diluent. The diluent can be a plasticizer, mineral spirits, water, or solvent (e.g., N-methyl-2-pyrrolidone, tetrahydrofuran, or ethyl acetate). For example, pastes made from benzoyl peroxide, ketone peroxides (e.g., methyl ethyl ketone peroxide), hydroperoxides (e.g., cumene hydroperoxide), peroxyesters (e.g., t-butyl peroxy-2-ethylhexanoate), and diperoxyketals are all sold commercially.

The free-radical initiator for curing the compositions according to the present disclosure may also be a photoinitiator. Examples of useful photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); 1-hydroxycyclohexyl phenyl ketone; and acylphosphine oxide derivatives and acylphosphonate derivatives (e.g., bis(2,4,6-trimethylbenzoyl)phenylphosphine oxide, diphenyl-2,4,6-trimethylbenzoylphosphine oxide, isopropoxyphenyl-2,4,6-trimethylbenzoylphosphine oxide, or dimethyl pivaloylphosphonate). Many photoinitiators are available, for example, from BASF under the trade designation “IRGACURE”. The photoinitiator may be selected, for example, based on the desired wavelength for curing and compatibility with the polymeric resin desired to be cured. When photochemical curing of the composition according to the present disclosure is desired, a photoinitiator can be included in the composition according to the present disclosure to make a one-part curable composition. Any useful amount of photoinitiator may be included the composition. In some embodiments, a photoinitiator is included the composition in an amount up to 3, 2.5, 2, or 1 percent by weight, based on the total weight of the composition.

The present disclosure provides a method of repairing a damaged surface. The method includes combining the composition described above in any of its embodiments with an organic peroxide or hydroperoxide, applying the composition comprising the organic peroxide or hydroperoxide to the damaged surface; and curing the composition on the damaged surface.

The present disclosure provides a cured composition made from the curable composition according to any of the above embodiments as well as an article comprising the cured composition on a surface.

One application of compositions according to the present disclosure are curable body repair materials useful in the repair of damaged vehicles and other equipment (e.g., cars, trucks, watercraft, windmill blades, aircraft, recreational vehicles, bathtubs, storage containers, and pipelines). Curable body repair materials can include two reactive components (e.g., a curable polymeric resin and catalyst or initiator) which are mixed together to form the curable body repair material.

In some embodiments of the method of the present disclosure, the damaged surface to be repaired is on at least a portion of a vehicle. Similarly, in some embodiments of the article of the present disclosure, the article is a portion of a vehicle.

The process of repairing dents and other damage using body repair materials can present challenges. For repairing an automobile, for example, a technician typically mixes the two reactive components and then uses a squeegee to spread the repair compound onto the surface of the vehicle to roughly match the contour of the surface. As the curable polymeric resin reacts with the curative or initiator, it hardens to a state where it can be shaped to match the contour of the vehicle before it was damaged. During this hardening process, the repair compound typically transitions from a state of soft, gelled material to a state of moderately hard material that is relatively easy to shape with an abrasive article (e.g., sandpaper) to a state of hard material. Body repair materials typically require handling in a relatively narrow time window. Premature sanding of body repair material before it has reached a critical amount of cure results in sandpaper becoming plugged reducing its effectiveness, the surface of the body repair material becoming rough, and sometimes the body repair material peeling away from the surface of the vehicle. If this situation occurs, then typically the body repair material has to be partially removed (usually by sanding) such that another layer of body repair material can be put on top and properly shaped. Furthermore, it is challenging for body repair materials to adhere well to a variety of common repair surfaces (e.g., aluminum, galvanized steel, E-coats, primers, and paints).

The composition according to the present disclosure has multiple advantages as a body repair composition. Typically and advantageously, in many embodiments, the composition according to present disclosure quickly develops adhesion to a surface (e.g., aluminum, galvanized steel, composite, E-coats, primers, and paints) to which it is applied. This is shown by the smooth transition that can be achieved for body filler compositions according to the present disclosure and a substrate to which they are applied as shown in Table 4, below. Typically and advantageously, in many embodiments, the composition according to present disclosure can be readily sanded with 20 or 25 minutes of being applied to a surface and cannot be readily scratched off the surface.

### Some Embodiments of the Disclosure

In a first embodiment, the present disclosure provides a composition comprising:

a liquid polyester resin comprising at least one α,β-unsaturated ester group;

a tertiary amine accelerator; and

up to five, four, three, two, or one percent by weight of a reactive diluent having a flash point up to 150° C.

In a second embodiment, the present disclosure provides the composition of the first embodiment, wherein the composition comprises up to 15 percent by weight of volatile organic compounds.

In a third embodiment, the present disclosure provides a composition comprising:

a liquid polyester resin comprising at least one α,β-unsaturated ester group;

a tertiary amine accelerator; and

up to 15 percent by weight of volatile organic compounds.

In a fourth embodiment, the present disclosure provides the composition of the second or third embodiment, wherein the composition comprises up to 10 percent volatile organic compounds.

In a fifth embodiment, the present disclosure provides the composition of any one of the second to fourth embodiments, wherein the composition comprises up to 5 percent volatile organic compounds.

In a sixth embodiment, the present disclosure provides the composition of any one of the first to fifth embodiments, wherein the reactive diluent or volatile organic compounds have a flash point up to 100° C.

In a seventh embodiment, the present disclosure provides the composition of any one of the first to sixth embodiments, wherein the liquid polyester resin comprises a dicyclopentadiene-modified unsaturated polyester resin.

In an eighth embodiment, the present disclosure provides the composition of the seventh embodiment, wherein the liquid polyester resin comprises a dicyclopentenyl-end-capped unsaturated polyester resin.

In a ninth embodiment, the present disclosure provides the composition of any one of the first to eighth embodiments, wherein the liquid polyester resin comprises an unsaturated polyester resin, wherein the at least one α,β-unsaturated ester group comprises an internal olefin. (This unsaturated polyester resin need not be a dicyclopentadiene-modified unsaturated polyester resin).

In a tenth embodiment, the present disclosure provides the composition of any one of the first to ninth embodiments, wherein the liquid polyester resin comprises allyl ether groups.

In an eleventh embodiment, the present disclosure provides the composition of any one of the first to tenth embodiments, wherein the liquid polyester resin has a number average molecular weight in a range from 500 grams per mole to 5000 grams per mole.

In a twelfth embodiment, the present disclosure provides the composition of any one of the first to eleventh embodiments, further comprising one or more reactive compounds having a flash point of greater than 150° C. and having at least one of an amino, mercaptan, epoxy, hydroxy, or olefin group.

In a thirteenth embodiment, the present disclosure provides the composition of the twelfth embodiment, wherein the one or more reactive compounds comprises at least one mercaptan group.

In a fourteenth embodiment, the present disclosure provides the composition of the twelfth or thirteenth embodiment, wherein the one or more reactive compounds comprises at least one epoxy group.

In a fifteenth embodiment, the present disclosure provides the composition of the fourteenth embodiment, wherein at least one of the one or more reactive compounds is an epoxy resin.

In a sixteenth embodiment, the present disclosure provides the composition of any one of the twelfth to fifteenth embodiments, wherein the one or more reactive compounds comprises a compound represented by formula (HD)₁₋₄-R, wherein each D is independently —S— or —N(H)— and R is a monovalent alkyl, alkenyl, or polyalkyleneoxy or a multivalent alkylene, alkenylene, or polyalkyleneoxy that is interrupted by at least two ether (i.e., —O—), amine (i.e., —N(H)—), amide (i.e., —N(H)—C(O)—), thioester (i.e., —S—C(O)—), or ester (i.e., —O—C(O)—) groups or a combination thereof.

In a seventeenth embodiment, the present disclosure provides the composition of the sixteenth embodiment, wherein the compound represented by formula (HD)₁₋₄-R is represented by formula HD-R¹-Q-R², wherein R¹ is alkylene that is interrupted by at least one —N(H)— or —O—; Q is —N(H)—C(O)—, —S—C(O)—, or —O—C(O)—; and R² is alkyl or alkenyl.

In an eighteenth embodiment, the present disclosure provides the composition of the sixteenth or seventeenth embodiment, wherein the compound is H₂N(CH₂CH₂NH)₄C(O)(CH₂)₇C(H)═C(H)—(CH₂)₃CH₃.

In a nineteenth embodiment, the present disclosure provides the composition of any one of the first to eighteenth embodiments, wherein the composition further comprises an epoxy vinyl ester resin.

In a twentieth embodiment, the present disclosure provides the composition of any one of the first to fifteenth embodiments, wherein the tertiary amine comprises at least one N,N-dialkyl toluidine, where each alkyl group is independently methyl, ethyl, hydroxyethyl, hydroxylpropyl, or isopropyl.

In a twenty-first embodiment, the present disclosure provides the composition of any one of the first to twentieth embodiments, wherein the composition is curable at room temperature.

In a twenty-second embodiment, the present disclosure provides the composition of any one of the first to twenty-first embodiments, further comprising at least one of ceramic beads, polymer beads, silica, hollow ceramic elements, hollow polymeric elements, alumina, zirconia, mica, dolomite, wollastonite, fibers, talc, calcium carbonate, or clay.

In a twenty-third embodiment, the present disclosure provides the composition of any one of the first to twenty-second embodiments, wherein the composition is free of triethylene glycol divinyl ether. In a twenty-fourth embodiment, the present disclosure provides the composition of any one of the first to twenty-third embodiments, wherein the composition is free of vinyl ethers.

In a twenty-fifth embodiment, the present disclosure provides the composition of any one of the first to twenty-fourth embodiments, wherein the composition is free of ethylene glycol dicyclopentenyl ether (meth)acrylate and propanediol dicyclopentenyl ether (meth)acrylate.

In a twenty-sixth embodiment, the present disclosure provides the composition of any one of the first to twenty-fifth embodiments, wherein the composition is free of lauryl (meth)acrylate.

In a twenty-seventh embodiment, the present disclosure provides the composition of any one of the first to twenty-sixth embodiments, wherein the liquid polyester resin is not prepared from an alkoxylated 2-butene-1,4-diol.

In a twenty-eighth embodiment, the present disclosure provides the composition of any one of the first to twenty-seventh embodiments, packaged as a two-part body repair composition, wherein a first part comprises the composition and a second part comprises a free-radical initiator.

In a twenty-ninth embodiment, the present disclosure provides the composition of the twenty-eighth embodiment, wherein the free-radical initiator comprises at least one of an organic peroxide or organic hydroperoxide.

In a thirtieth embodiment, the present disclosure provides a method of repairing a damaged surface, the method comprising:

combining the composition of any one of the first to twenty-ninth embodiments with at least one of an organic peroxide or organic hydroperoxide;

applying the composition comprising the organic peroxide or organic hydroperoxide to the damaged surface; and

curing the composition on the damaged surface.

In a thirty-first embodiment, the present disclosure provides the method of the thirtieth embodiment, wherein the damaged surface is on at least a portion of a vehicle.

In a thirty-second embodiment, the present disclosure provides the method of the thirtieth or thirty-first embodiment, wherein curing is carried out at room temperature.

In a thirty-third embodiment, the present disclosure provides a cured composition prepared from the composition of any one of the first to twenty-ninth embodiments or prepared by the method of any one of the thirtieth to thirty-second embodiments.

In a thirty-fourth embodiment, the present disclosure provides an article prepared by curing the composition of any one of the first to twenty-ninth embodiments or prepared by the method of any one of the thirtieth to thirty-second embodiments.

In order that this disclosure can be more fully understood, the following examples are set forth. It should be understood that these examples are for illustrative purposes only, and are not to be construed as limiting this disclosure in any manner.

### EXAMPLES

The following abbreviations are used to describe the examples: ° C.=degrees Centigrade, g=grams, kPa=kilopascal, mm=millimeter, psi=pounds per square inch, wt. %=weight percent, GPC=gel permeation chromatography.

Unless otherwise reported, all ratios are by dry weight.

### Liquid Resin A

A flask was charged with 53.06 g of diethylene glycol, 68.9 g of maleic acid, and 0.05 g of titanium butoxide. The flask was slowly heated to 160° C. for 8 hours, and water (13 mL) was azotropically distilled out. Then vacuum of 300 torr was applied for 4 hours for removal of water. The temperature was cooled down to 80° C. Then 21.42 g of allyl glycidyl ether was added. The reaction was kept at 80° C. for 5 hours. The number average molecular weight was determined from the collected amount of water to be 1228 grams per mole.

### Liquid Resin B

Liquid Resin B was synthesized from dicyclopentadiene monomer (DCPD), maleic anhydride, and a 3-methyl-1,5-pentane diol (53.5 g). First, DCPD (25.9 g), maleic anhydride (38.2), and less than an equivalent of water, were reacted at a temperature about 150° C., which is below the decomposition temperature of DCPD. The 3-methyl-L5-pentane diol was added to the reaction mixture, and gradually the temperature was increased to 195° C. to form a low-molecular-weight unsaturated polyester resin. The number average molecular weight was determined from the collected amount of water to be to be 1,400 grams per mole. Liquid Polyester Resin B had a DCPD moiety on both ends.

### Liquid Resin C

Liquid Resin C, obtained from Polynt Composites, North Kansas City, Mo., as a specialty material without trade designation was a viscous liquid resin having a weight-average molecular weight 4,300 as determined by GPC using the test method, below. It was made from DCPD, maleic anhydride, and diethylene glycol with DCPD accounting for 40 wt % of the polymer composition.

### Liquid Resin D

Liquid Resin D was an unsaturated polyester resin prepared from diethylene glycol, maleic anhydride, and phthalic anhydride. It was obtained from Polynt Composites as a specialty material without trade designation. It had a weight average molecular weight of approximately 2,500 as determined by GPC using the test method, below.

### Liquid Resin E

Liquid Resin E was a vinyl hybrid liquid resin obtained under the trade designation “ADVALITE 35065” from Reichhold LLC, Durham, N.C. It is made from diethylene glycol, neopentyl glycol, ortho-phthalate, tetrahydrophthalate, and methacrylate acid.

### GPC Method

The sample was prepared in duplicate. Solutions of samples at a concentration of approximately 3 mg/mL in THF was prepared. The samples were allowed to dissolve overnight on an orbital shaker. The sample solutions were filtered through 0.2μ PTFE syringe filters and analyzed by GPC using an Agilent 1260 instrument from Agilent Technologies and a differential refractive index detector. The column set was Agilent Plgel MIXED-C and Mixed-E, 2×300×7.5 mm I.D. The column heater was set at 40° C. The eluent was THF (stabilized), and the flow rate was 1.0 mL/min. A 60-4 injection was used.

The molecular weight calculations were based upon a calibration made of narrow dispersity polystyrene (PS) molecular weight standards ranging in molecular weight from 6.0E+05 to 162 g/mol.

The calculations were performed using Agilent GPC/SEC software from Agilent Technologies.

Abbreviations for materials and reagents used in the examples are as follows:
AC: An amide, obtained under the trade designation “AMERIBOND E-102” from Ameritech Corporation, Marietta, Ga., having the structural formula H₂N(CH₂CH₂NH)₄C(O)(CH₂)₇C(H)═C(H)—(CH₂)₃CH₃.
AS: Amorphous silica, obtained under the trade designation “ZEOTHIX 265” from Huber Engineered Materials, Overland Park, Kans.
BPO: A blue dyed, 50 wt. % benzoyl peroxide paste, obtained from Raichem, s.r.l., Reggio Emilia, Italy.
CA: CALCIUM CARBONATE, obtained under the trade designation “Gamaco” from IMERYS, Roswell, Ga.
DVE: Triethylene glycol divinyl ether, obtained under the trade designation “DVE-3” from BASF Corporation, Florham Park, N.J. Its reported flash point is 113° C.
EP: an undiluted clear difunctional bisphenol A/epichlorohydrin derived liquid epoxy resin, obtained under the trade designation “EPON Resin 828” from Hexion, Inc., Stafford, Tex.
MFA: a mixture of a methacrylated fatty acids of eight to eighteen carbon chain length, obtained under the trade designation “MC818” from Dixie Chemical Company, Inc, Pasadena, Tex. The bio-based content of MC818 is approximately 60%. Its reported flash point is greater than 200° C.
SH: a mercaptan terminated liquid resin, obtained under the trade designation “GABEPRO GPM-800” from Gabriel Performance Products, Akron, Ohio Its reported flash point is 258° C.
GB: Glass bubbles, obtained under the trade designation “S-22” from 3M Company. St. Paul, Minn.
Talc: Talc, obtained under the trade designation “GRADE AB” from Luzenac America, Inc., Centennial, Colo.
TiO₂: Titanium dioxide, obtained under the trade designation “KRONOS 2310” from Kronos Worldwide, Inc., Dallas, Tex.
TDEA: N-(p-tolyl)diethanolamine, obtained from BASF Corporation, Florham Park, N.J.
PW: Paraffin wax, having a melting point of 125° F.-130° F., obtained under the trade designation “60-0254” from Frank B. Ross Co., Ins., Rahway, N.J.

### Examples 1 to 4

30 grams of the Liquid Polyester Resin shown in Table 1, below, 0.3 g of TDEA, and 1.2 grams BPO were manually mixed at 25° C. in a 6-oz. (170 gram) screw-cap plastic container until homogeneous. For Examples 3 and 4, 7.5 g of Liquid Polyester Resin E was mixed with 22.5 g of the other listed Liquid Polyester Resin.

The timer was started, and immediately the sample was mixed with the hardener for 45 seconds to one minute with a tongue depressor. The sample was periodically checked for gel with the tongue depressor. Gel was achieved when the mixture began to form a gelatinous mass and snapped back when pulled from the container. When gel was achieved, the timer was stopped and the gel time was recorded. Peak temperature was recorded with an IR thermometer.

The gel time and exothermic peak temperature were recorded and shown in Table 1, below.

TABLE 1
Gel Time and Exothermal Peak Temperature

| | | | Peak |
|---|---|---|---|
| | Liquid | Gel Time | Temperature |
| Example | Resin | (seconds) | (° F.) |
| 1 | E | 235 | 295 |
| 2 | A | 380 | 143 |
| 3 | D/E | 415 | 128 |
| 4 | C/E | 265 | 148 |

### Examples 5 and 6

Examples 5 and 6 were carried out as described for Examples 1 to 4 with the modification that in Example 5, 6 g of SH was combined with 24 g of Liquid Resin E, and in Example 6, 6 g of SH was combined with 18 g of Liquid Resin E and 6 g of Liquid Resin B. The gel time and exothermic peak temperature were recorded and shown in Table 2, below.

### Examples 7 to 9

Examples 7 to 9 were carried out as described for Illustrative Examples 1 to 4 with the modification that in Example 7, 9 g of EP was combined with 21 g of Liquid Resin E. In Example 8, 6 g of EP, 18 g of Liquid Resin B, and 6 g of SH were used. In Example 9, 7.125 g of EP, 21.375 g of Liquid Resin B, and 1.5 g of AC were used. The gel time and exothermic peak temperature were recorded and shown in Table 2, below.

### Example 10 and Illustrative Example A

Example 10 and Illustrative Example A were carried out as described for Examples 1 to 4 with the modification that in Example 10, 9 g of MFA was combined with 21 g of Liquid Resin E, and in Illustrative Example A, 3 g of DVE, 18.9 g of Liquid Resin B, and 8.1 g of MFA were used. The gel time and exothermic peak temperature were recorded and shown in Table 2, below.

TABLE 2
Gel Time and Exothermal Peak Temperature for
Examples 5 to 10 and Illustrative Example A

| | | | Peak |
|---|---|---|---|
| | | Gel Time | Temperature |
| Example | Composition | (seconds) | (° F.) |
| 5 | Liquid Resin E/SH | 140 | 233 |
| 6 | Liquid Resin C/Liquid Resin E/SH | 145 | 217 |
| 7 | Liquid Resin E/EP | 230 | 223 |
| 8 | Liquid Resin B/EP/SH | 215 | 168 |
| 9 | Liquid Resin B/EP/AC | 290 | 148 |
| 10 | Liquid Resin E/MFA | 250 | 255 |
| A | Liquid Resin C/MFA/DVE | 295 | 195 |

### Examples 11 to 20 and Illustrative Example B

50.0 grams of Liquid Polyester Resin E was added to a 250 mL screw-cap plastic container at 25° C. and then 0.2 gram TDEA was added. 1.40 grams TiO₂ was blended into the liquid polyester resin using a high-speed mixer until a homogeneous mixture was obtained. 0.50 grams AS, 20.0 grams Talc, 23.5 grams CA, 0.4 grams PW and 4.0 grams GB were sequentially added, each component manually mixed into the composition until homogeneous before the next component. The procedure was repeated with the compositions listed in Table 3.

TABLE 3

| | Composition (wt. %) | | | | | | | | | | |
|---|---|---|---|---|---|---|---|---|---|---|---|
| | Ex. | Ex. | Ex. | Ex. | Ex. | Ex. | Ex. | Ex. | Ex. | Ex. | I.E. |
| | 11 | 12 | 13 | 14 | 15 | 16 | 17 | 18 | 19 | 20 | B |
| LPR E | 50 | | 14 | 16 | 40 | 10 | 35 | | | 35 | |
| LPR A | | 56 | | | | | | | | | |
| LPR D | | | 41 | | | | | | | | |
| LPR B | | | | 41 | | 30 | | 30 | 32 | | 32 |
| SH | | | | | 10 | 10 | | 11 | | | |
| EP | | | | | | | 15 | 10 | 13 | | |
| AC | | | | | | | | | 2 | | |
| MFA | | | | | | | | | | 15 | 10 |
| DVE | | | | | | | | | | | 8 |
| TDEA | 0.2 | 0.5 | 0.4 | 0.4 | 0.3 | 0.3 | 0.3 | 0.5 | 0.3 | 0.3 | 0.5 |
| TiO₂ | 1.4 | 1 | 1 | 1 | 1 | 1 | 1.5 | 1 | 1 | 1.5 | 1 |
| CA | 23.5 | 32.1 | 32 | 32 | 30 | 38.7 | 20 | 38 | 41.7 | 14.4 | 24 |
| Talc | 20 | 10 | 11.3 | 9.6 | 16 | 10 | 25 | 9.5 | 10 | 30 | 22 |
| AS | 0.5 | | | | 0.4 | | 0.9 | | | 0.5 | 0.3 |
| PW | 0.4 | 0.4 | 0.3 | | 0.3 | | 0.3 | | | 0.3 | 0.2 |
| GB | 4 | | | | 2 | | 2 | | | 3 | 2 |

### Evaluations

The following evaluations were performed on the compositions in Table 3: A 105 mm by 50 mm steel panel was manually sanded with an 80 grit sandpaper to provide a rough surface. 100 grams of the body filler composition was thoroughly mixed with 2 grams BPO at 21° C. and applied to the sanded steel panel. After curing for 20 minutes at 21° C., the sample was shape sanded with 80 grit sandpaper, and then sanded along the edge of the material on the panel attempt to get a smooth transition between the filler and the steel panel. The ability to achieve a smooth transition is an indication of adhesion between the body filler and the steel panel. “Roll back” refers to the edge of the body filler pulling away from the steel panel. The shape time is the time after which the body filler can be shape sanded, without plugging the sand paper. It is desirable for body fillers to be shape sanded within 20 minutes. The ease of sanding was also qualitatively evaluated and reported in Table 4, below. Finally, the material was tested for scratch resistance. Scratch resistance was qualitatively evaluated to see if the body filler was hardened enough and could not be scratched within 50 minutes. The results of the evaluations are listed in Table 4.

TABLE 4

| | Shape time | Smooth | Scratch | |
|---|---|---|---|---|
| Sample | (minutes) | Transition | resistance | Sandability |
| 11 | 20 | obtainable | Yes | hard |
| 12 | 20 | obtainable | Yes | easy |
| 13 | 25 | roll back | no | easy |
| 14 | 20 | obtainable | Yes | easy |
| 15 | 20 | obtainable | Yes | easy |
| 16 | 20 | obtainable | Yes | easy |
| 17 | 20 | obtainable | Yes | hard |
| 18 | 20 | obtainable | Yes | easy |
| 19 | 25 | roll back | no | hard |
| 20 | 25 | roll back | no | hard |
| B | 20 | obtainable | Yes | easy |

Sandability can also be evaluated by the following method. The mass of panel and cured filler can be measured. After curing for 12 minutes at 21° C., the sample can be sanded with 80 grit sandpaper for 30 seconds by means of a dual action sander, after which the panel can be reweighed and the amount of body filler removed determined. After another 8 minutes, the sample can again be sanded and the additional amount of body filler recorded. Different cure times may be used in the evaluation if desired.

Various modifications and alterations of this disclosure may be made by those skilled the art without departing from the scope and spirit of the disclosure, and it should be understood that this disclosure is not to be unduly limited to the illustrative embodiments set forth herein.

1. A composition comprising:
a liquid polyester resin comprising at least one α,β-unsaturated ester group;
a tertiary amine accelerator;
up to five percent by weight of a reactive diluent having a flash point up to 150° C., and
one or more reactive compounds having a flash point of greater than 150° C. and having at least one of a mercaptan or epoxy group.

2. The composition of claim 1, wherein the composition comprises up to 15 percent by weight of volatile organic compounds, based on the total weight of the composition.

3. The composition of claim 1, wherein the liquid polyester resin comprises a dicyclopentadiene-modified unsaturated polyester resin.

4. The composition of claim 3, wherein the liquid polyester resin comprises a dicyclopentenyl-end-capped unsaturated polyester resin.

5. The composition of claim 1, wherein the liquid polyester resin comprises allyl ether groups.

6. The composition of claim 1, wherein the one or more reactive compounds having a flash point of greater than 150° C. further comprise compounds having at least one of an amino, hydroxy, or olefin group.

7. The composition of claim 1, wherein the one or more reactive compounds comprises at least one mercaptan group.

8. The composition of claim 1, wherein the one or more reactive compounds comprises at least one epoxy group.

9. The composition of claim 1, further comprising at least one of ceramic beads, polymer beads, silica, hollow ceramic elements, hollow polymeric elements, alumina, zirconia, mica, dolomite, wollastonite, fibers, talc, calcium carbonate, or clay.

10. The composition of claim 1, wherein the tertiary amine comprises at least one N,N-dialkyl toluidine, where each alkyl group is independently methyl, ethyl, hydroxyethyl, hydroxylpropyl, or isopropyl.

11. The composition of claim 1, packaged as a two-part body repair composition, wherein a first part comprises the composition and a second part comprises an organic peroxide or organic hydroperoxide.

12. An article prepared from the composition of claim 11 by combining the first part and the second part and curing the composition.

13. A method of repairing a damaged surface, the method comprising:
combining the composition claim 1 with at least one of an organic peroxide or an organic hydroperoxide;
applying the composition comprising at least one of the organic peroxide or the organic hydroperoxide to the damaged surface; and
curing the composition on the damaged surface to provide a cured composition.

14. The method of claim 13, wherein the damaged surface is on at least a portion of a vehicle.

15. The method of claim 13 or 11, wherein curing is carried out at room temperature.

16. The composition of claim 2, wherein the volatile organic compounds have a flash point up to 100° C.

17. The composition of claim 1, wherein at least one of the one or more reactive compounds is an epoxy resin.

18. The composition of claim 1, wherein the liquid polyester resin has a number average molecular weight in a range from 500 grams per mole to 5000 grams per mole.

19. The composition of claim 1, further comprising an epoxy vinyl ester resin.

20. The composition of claim 1, wherein the composition is free of vinyl ethers.
